(19) United States
(12) Patent Application Publication
(10) Pub. No.: US 2025/0262470 A1
(43) Pub. Date: Aug. 21, 2025

(54) Stationary Closed-Kinetic Chain Neuromuscular Exercise Apparatus

(71) Applicant: Raymond B. Vigil, Centennial, CO (US)

(72) Inventor: Raymond B. Vigil, Centennial, CO (US)

(21) Appl. No.: 18/583,666

(22) Filed: Feb. 21, 2024

(51) Int. Cl. A63B 21/00; A63B 21/068; A63B 23/02

(52) U.S. Cl. CPC A63B 21/00178; A63B 21/00047; A63B 21/068; A63B 21/4033; A63B 23/0244; A63B 2214/00; A63B 2225/09

(57) ABSTRACT

The present invention embodiment discloses a stationary closed-kinetic chain free-standing five-piece upper and lower extremity neuromuscular exercise station. The apparatus comprises a rectangular shaped diamond plate steel standing platform as base and counterweight with a welded eyelet and a welded-angled steel pipe flange situated towards one end. A polyoxymethylene (POM) bushing disposes within the pipe flange and receives a round polished steel shaft. An ultra-high molecular weight polyolefin (UHMWPE) handgrip houses steel bearings or bushing. The said handgrip disposes onto end of the steel shaft. A plurality of anchor endcaps disposes onto one end of the shaft for resistive strengthening. The said apparatus serves to strengthen the body core, scapular stabilizers, weakened rotator cuff muscles by the user grasping the moveable handgrip and moving the carriage along the motion directed steel guide rail using body weight to push the carriage along into shoulder flexion, abduction, adduction, or a combination thereof.

### CROSS-REFERENCE TO RELATED APPLICATIONS

Provisional Application #63447889

### STATEMENT REGARDING FEDERALLY SPONSORED RESEARCH OR DEVELOPMENT

No research and no development costs of the invention were made using federally sponsored money.

### REFERENCE TO A “SEQUENCE LISTING” (IF APPLICABLE)

Not Applicable

### BACKGROUND OF THE INVENTION

### Field of Endeavor

Physical therapy, occupational therapy, athletic training, and related “therapies” may work independently or consecutively and/or exclusively to assess movement disorder, strengthen the body core and weak shoulder muscles and/or rehabilitate the post-operative shoulder rotator cuff during healing Phases I-IV. Phase I is passive (no muscle contraction) range of motion only. Phases II-IV (active muscle contraction motions) with Phase IV-return to prior level of function. The term “kinetic chain” referenced in this document means an activation sequence of human movement and can be differentiated as open-kinetic chain or closed-kinetic chain. A closed-kinetic chain means all the links in the chain are fixed with respect to the ground and/or platform, whereas open-kinetic chain means a link or links are not fixed to the ground, e.g. a common free-weight biceps curl exercise is an open-kinetic chain exercise and a common push-up is a closed-kinetic chain exercise which in essence links the core to the extremity in a full circle to the ground or platform. Movement science is implemented for the assessment of movement diagnosis with the goal of reducing abnormal tissue loading and subsequent tissue deterioration and pain. The said therapies may evaluate movement impairment and then work to habilitate and otherwise enhance the underdeveloped or weak body core and upper extremity in strength, speed, and accuracy of throwing a ball or object using an overhand method and/or to habilitate or rehabilitate the lower extremity using a stationary closed-kinetic chain neuromuscular re-education methods of exercising with instructions to correct the movement disorder.

### Cpc Classification:

A63B 21/00; A63B 21/04; A63B 21/08; A63B 21/16; A63B 21/185; A63B 21/0125; A63B 21/062; A63B 21/068; A63B 21/4033; A63B 21/4001; A63B 21/4019; A63B 23/12; A63B 23/0222; A63B 23/0405; A63B 69/006.

### SUBJECT MATTER

1. The subject matter concerns the much-needed and novel invention of a specific stationary and non-mobile neuromuscular strengthening exercise device that is necessary to bridge the rehabilitative medicine gap between passive (no muscle contractions) motion exercises of the upper extremity following rotator cuff surgery and the surgeon's directives for initiation of active-assistive (limited muscle contractions) strengthening exercises. Following shoulder surgery, it is usual and customary to immobilize the upper extremity with the use of a cloth sling or a foam pad immobilizer to provide a favorable position of the arm and to provide the safe environment for which the operated and sutured tissues can begin to unify and heal without mechanical tendon loading. Musculotendinous sutures are designed to resorb to allow for tendon healing and subsequent tendon loading in about 6-8 weeks. Permanent boney anchors may also be used and are designed to mechanically join the tendon to the bone. Tendon loading may begin in about 6-8 weeks after surgery which means the affected joint(s) is/are immobilized to prevent the tensile forces upon the operated tissues during the early healing phases due to the delicate properties of the tissues. Unfortunately, prolonged immobilization, with significant frequency, results in muscle disuse atrophy, stiffening of the shoulder joint, the loss of functional use, acquiring substitution patterns of movement and scapular dyskinesis which is defined as the abnormal movement due to the afore mentioned symptoms. In order for the involved person to recover the loss of joint motion and to regain the prior level of function due to the stiffening effects, it requires a quite lengthy and painful rehabilitation. The stiffening of the shoulder joint can occur from several causes. The primary cause may involve the bleeding and swelling in the location of the surgery. Blood and associated body fluids contain sugars and these blood sugars serve as an adhesive agent to “glue” the adjacent tissues (such as tendons, fascia, joint capsule, bursae, and the like) together thus creating loss of the necessary tendon gliding along the normal anatomical pathways. The prolonged contact of the said soft tissues during the immobilization phase (Phase I) may create the ideal environment for protein bonds to also form between the said soft tissues and form scar tissues which further limits the gliding motions that normally occur between the associated soft tissues during active (contractile components) range of motion of the shoulder complex. Other shoulder rehabilitation devices, systems, exercise methods and prior art lack the critical component for providing the preservation of joint play during the acute healing phases as described above. The novel stationary closed-kinetic chain neuromuscular apparatus provides the opportunity to move the shoulder joint while preserving the protective elements necessary to promote tendon and associated soft tissue healing. The results are a less painful and passive range of motion exercise for an ideal shoulder rehabilitation experience during the early phases of rehabilitation. The said shoulder complex consists of skeletal tissues, contractile tissues, and non-contractile tissues as well as the glenohumeral joint and the scapulothoracic joint. The skeletal tissues include but are not limited to the thorax, the scapula, the clavicle, and the humerus. Contractile tissues (muscles) include but are not limited to the trapezius, the deltoid, the biceps brachii, the triceps brachii, the supraspinatus, the infraspinatus, the teres minor, the teres major, the subscapularis, the subclavius, and the pectoral muscles as well as the scapular stabilizing muscles. The non-contractile tissues include the tendons, ligaments, cartilage, joint capsule, vascular structures and contents, lymph structures and contents, nerve tissues, bursae, facia, and skin. All of these tissues play a key role in a successful healing of a shoulder injury with or without surgical intervention.

The said stationary closed-kinetic chain neuromuscular exercise novel invention serves to provide a stop-gap measure to the prolonged immobilization by introducing passive mobility of the glenohumeral complex without adding significant unnecessary risk to impeding the normal healing processes for the operated and sutured tissues. This stop-gap treatment option, when implemented with this stationary closed-kinetic chain method of neuromuscular exercises correctly with skilled supervision, provides passive motion to the involved side during the early phase (Phase I) which is passive range of motion only. This is accomplished by positioning the user on the stationary steel platform then actively grasping the handgrip with the noninvolved side and then passively placing and resting the effected side hand and wrist onto the non-involved side wrist and forearm. Once the involved side is positioned appropriately the individual is then instructed to actively move the non-involved side into flexion to generate the passive range of motion force to the involved side without whole body movements and without mechanical tendon loading of the involved side as the involved side beings to move into flexion passively. The said stationary closed-kinetic chain neuromuscular exercise method encourages passive skeletal approximation of the humeral head onto the glenoid surface of the scapula without excessive forces thus creating the stationary closed-kinetic chain method of passive range of motion. Prior art and prior methods of care do have a closed kinetic chain element as described above. During the said passive motion there is approximation of glenohumeral joint surfaces. This approximation of the joint surfaces serves to Capture The Scapula@ and assist in stabilizing the scapula in the desired anatomical position with directed motion. Scapular winging and dyskinesis is a very common disorder in individuals with weakened scapular muscles and in individuals who have had a surgical repair of the shoulder. The winged scapula takes on multiple forms but in essence it is the scapula migrating superiorly, posteriorly at the vertebral edge, rotating upwards, internally rotating, and tilting anteriorly in a dyskinetic manner which results in the distal acromion dropping on to the subacromial structures and causing pain and tissue damage. It is a frequent threat to successful shoulder rehabilitation. Advancement of the passive method of the stationary closed kinetic chain method of neuromuscular exercise prohibits the said dyskinesia and preserves the free space in the subacromial region which protects the involved rotator cuff tendons. Prior art does not address this critical issue. The above stationary closed-kinetic chain neuromuscular exercise progresses to partial body weight bearing of the involved arm onto the stationary steel guide rail during Phase II of the active-assistive exercise protocol. This novel technique may also be applied to the operated and non-operated sides using the said stationary close-kinetic chain neuromuscular method of exercise apparatus by encouraging the user's shoulder joint to flex and extend in the directed and prescribed motions while simultaneously holding and maintaining the scapula in the much desired dynamic positions. The precise reasoning for the Capture-the-Scapula® to occur is thought to relate to the primitive neuromuscular motor patterns that occur during growth and development when crawling is acquired and the scapula is stabilized by the supporting musculature. The stationary closed-kinetic chain neuromuscular exercise method facilitates the return of this primitive neuromuscular pathway by approximating the head of the humerus on to the glenoid surface while simultaneously moving the shoulder in flexion or abduction or a combination thereof. Once the motor pattern is re-established it is preserved as the strength of the shoulder progresses through the post-operative phases. The user's partial body weight application to the scapula and upper extremity and the stationary closed kinetic chain approach to rehabilitation provides the necessary neuromuscular (neurological elements and associated muscle connections) facilitation for preservation of the neuromuscular connection between the shoulder complex's neurological sensory receptors and the cerebrum. This method of neuromuscular exercises provides a sensory-motor loop which in turn sustains the neuromuscular connection to the at-risk shoulder muscles. A systematic review study published in the British Medical Journal Open Sport & Exercise Medicine (2020; 6: e000683. doi: 10.1136/bmjsem-2019-000683) found evidence that integrating the closed-kinetic chain form of exercises during shoulder rehabilitation may increase axioscapular muscle recruitment. The referenced axioscapular muscle recruitment is necessary clinically for stabilization of the scapula for ideal rehabilitation or habilitation. The study also found the closed-kinetic chain method of exercise produced lower trapezius muscle ratios of contraction which inhibits abnormal active muscular substitution patterns which in turn reduce the pathological sheer and tensile demands on the rotator cuff muscles and the common tendon which is necessary for proper healing of the involved soft and boney tissues. In addition to the said mal-effects to the joint complex during immobilization, the scapular muscles also are at risk for atrophy and weakening. The weakened scapular muscles result in a disproportionate strength between the substitution muscles and the scapular stabilizer muscles which creates a dysfunctional active motion pattern of the scapula said term ‘scapular winging’ or ‘snapping scapula’ which leads to prolonged pain due to the abnormal approximation of the acromion onto the subacromial structures and thus, delaying the recovery process. An article published in 2022 by Dube, et. al. Archives of Physiotherapy (2022) 12:11, found that scapular stabilization was a key component for restoring normal shoulder activity following a bout of rotator cuff related shoulder pain. The article continued to emphasize the importance of closed-kinetic chain neuromuscular exercise in prone, sitting, and standing to be included in the treatment regimen particularly in standing because it is a more functional position and better reflects functional activities. The above article's reported exercises were completed without equipment indicating the absence of prior art. The absence of the necessary equipment, other than wall push-ups, to carry out the disclosed closed-kinetic chain neuromuscular exercise methods suggests that current technology does not have a designated stationary closed-kinetic chain neuromuscular apparatus which further emphasizes the need exists for the said novel apparatus. Most of the stabilization exercises identified in the said articles can be carried out using the proposed stationary closed-kinetic chain neuromuscular exercise novel invention at a much earlier time during the rehabilitation phases of healing. The current clinical standard for initiating passive range of motion following shoulder surgery is outdated in that there have been little advancements in physical therapy systems and methods in the past 50 years. The Codman's Exercise method of passive range of motion and/or the gentle pendulum exercise method has been the primary method of instruction for the involved individual's independent passive mobility exercises in the home following surgery and acute shoulder injury with pathology. Unfortunately, the Codman's exercises have limited benefits resulting in the presence of the said joint stiffening effects despite the goal to maintain joint integrity and mobility. These said pendulum exercises are open-chain and do not have the neuromuscular benefits of the closed-kinetic chain method of rehabilitation that the said stationary closed-kinetic chain apparatus provides. And, it is common for patients to create substitution patterns of motion over utilizing scapular protraction in place of the desired glenohumeral motion which results in glenohumeral joint stiffening because the glenohumeral motion is not occurring rather the scapula is moving abnormally along the thorax.

The current standard clinical progression from the said pendulum exercises in Phase I is to introduce use of an overhead reciprocal pulley system to aid the operated side in mobility during the beginning of Phase II of the rehabilitation protocol. The reciprocal pulley system cannot be introduced until after Phase I has been completed due to the risk of harm to the operated tissues, which provides ample time to acquire glenohumeral joint stiffening and abnormal scapular dyskinesia. The goal of Phase I is to allow the operated tissues to have an adequate time to heal without compromising the integrity of the surgically repaired tissues which means that the mal-effects of prolonged immobilization have already manifested in some form when the Phase II reciprocal pulley system is allowed to be safely introduced. The said novel stationary closed-kinetic chain standing neuromuscular exercise device allows for the initiation of passive motion during Phase I because the stationary component of the standing platform and the handgrip on the motion directed inclined steel shaft serve to protect the surgical sites by significantly avoiding contractile risk elements and control the passive glenohumeral motion in a pain free manner all while avoiding the unwanted and deleterious aberrant mechanical motions to act upon the surgically repaired sites. As with all rehabilitation post-operative protocols, a surgeon's approval is necessary for implementation of this stationary closed-kinetic chain method of exercises and apparatus. The early onset of the said invention allows for safe passive motion to inhibit the said deleterious effects of immobilization such as joint stiffening, scarring to the joint structures and to promote the neuromuscular and neurological propagation of afferent signals to the brain. A pilot in house EMG (electromyography) study has revealed electrical muscle activity of the supraspinatus is similar to measured muscle activity of prior EMG studies during supine passive range of motion completed by a skilled physical therapist. Also, preservation of the patient's neuromuscular pattern preserves the previously habilitated neuromuscular pattern of motion which will become necessary as the rehabilitation Phases progress from I to IV. During Phase II active-assistive range of motion is appropriate meaning that the involved contractile tissues may begin to be recruited (efferent neurological propagation) as the movement source and begin to apply gentle contractile forces to the involved muscles with light mechanical tendon loading for gentle strengthening of the operated sites. The said stationary closed-kinetic chain neuromuscular exercise unit can be incorporated into all Phases of the rehabilitation protocol and is not limited as is the case for all the referenced prior art. The prior art references for example, do not address Phase I which is a critical period for the said healing. There exists for example, the continuous passive motion machine (CPM) designed for moving the joint passively during the Phase I rehabilitation protocol post-operatively. Use of a CPM is usually in recumbent positions meaning muscle atrophy is not retarded. Not all surgeons prescribe CPM therapy and not all patients are qualified candidates for the CPM. The CPM requires the patient to be fit into the apparatus with the aid of a caregiver. Phases III-IV involves active strengthening methods and return to preoperative activities and prior levels of function such as return to sports or work. It is during Phases III-IV that the elastic resistive banding/tubing may be fastened to the said novel closed-kinetic chain neuromuscular apparatus by way of the anchor end caps or, to the steel guide bar directly via a felt-lined shaft clamp and hook or, to the steel inverted U-shaped eyelet at the base of the steel pipe flange and standing platform depending upon the choice of exercise desired. Common light wrist cuff weights may also be introduced by the therapist or trainer while using the novel closed-kinetic chain neuromuscular exercise apparatus for progressive muscle strengthening. An added feature is using bilateral and simultaneous closed-kinetic chain neuromuscular exercise machines provides for the simultaneous flexion, abduction, scaption or a combination thereof to both shoulders. This exercise is completed using a pair of the stationary closed-kinetic chain neuromuscular machines side by side with the user assuming the seated or kneeling positions. The user then grasps the handgrips and proceeds to flex and/or abduct bilaterally. This technique allows for the scapulae to stabilize bilaterally simultaneously and thus prevents scapular dyskinesia which is so often a problem in patients with shoulder injuries and/or weaknesses. It is a novel method to achieving scapular stability using the said method. Prior methods to achieve scapular stability have been push-ups, modified push-ups, and doorway stretches. All of these prior methods mentioned are dependent on a 90-degree angle. There are no inclined doorways nor inclined floors. However, mat tables, benches, and floor cushions may be employed for the push-up type exercises but the cushions are too unstable and the benches and mat tables are too advanced of an exercise option and as result, this novel closed-kinetic chain neuromuscular apparatus satisfies the need described.

2. For the throwing athlete, control of an object being thrown is dependent on the afore-mentioned anatomical structures. Typically, the non-injured athlete completes the physical task of throwing and training to throw very rapidly and therefore the training methods change from the said rehabilitation methods and techniques to quicker closed-kinetic chain neuromuscular exercises that involve using the same muscles and, when indicated, with a progressive and very rapid change in neuromuscular firing sequences. The key objectives in this method of neuromuscular exercising implement the said novel stationary closed-kinetic chain neuromuscular apparatus, is to set muscle spindle bias of the supraspinatus muscle prior to the other associated rotator cuff muscle contractions. It is beyond the scope of this document to explain spindle bias in detail. Basically, the muscle spindle is the intrafusal fiber that communicates with alpha motor and gamma efferent nerve activity. In short, the learning of the responsivity of the spindle is what matters. The supraspinatus muscle is key for ‘cocking’ the throwing mechanism. Therefore, it is essential that the supraspinatus contracts first to position (centering) the humeral head on the inferior glenoid of the scapula. This type of spindle bias can be described as a premotor plan between the cerebrum and the sensorimotor intrafusal muscle fiber structures used for throwing by way of the gamma-efferent motoneurons in the spinal cord. Implementing the specific neuromuscular methods described with the said novel apparatus addresses the kenisiomechanics of the shoulder complex so as to avoid said boney approximation of the subacromial structures. When the supraspinatus contracts as a later time in the sequence, the associated muscles overpower the supraspinatus resulting in less than ideal mechanics. The athlete and all patients of shoulder injuries must learn to position the head of the humerus appropriately onto the glenoid surface which may be said term ‘centering’ at the ideal location and position to allow for boney clearance without encroaching onto the soft tissues or onto the boney tissues. Excessive approximation of the humeral head and/or humeral tuberosities onto the distal inferior acromion damages the healthy soft tissues being caught in between the boney elements and damage may also occur to the periosteum of the bone. The said closed-kinetic chain neuromuscular exercise techniques take on a plyometric exercise approach using this said novel apparatus with an element of partial weight bearing and simultaneous strengthening to the involved muscles. Strengthening and appropriate muscle contraction sequencings can be improved with use of resistance bands anchored to the said apparatus and/or with light wrist cuff weights fastened to the wrist of the involved side and performed in said manner while implementing weight bearing-non weight bearing-weight bearing or a combination thereof with the novel said apparatus. The weight bearing aspect of this novel apparatus is unique. At times, it may become necessary to begin with weight bearing and then to lean the body away to lessen the compressive forces for a few degrees of active motion and then to reapply the compressive force for the learning of the desired motor pattern and subsequent strengthening of the periscapular muscles and the glenohumeral muscles. No prior art has been found in the literature, trade shows, or gyms that provide such a mechanism for stationary closed-kinetic chain neuromuscular exercise in the stated scenario. There are, however, many devices and techniques that involve the afore mentioned open-kinetic chain methods of exercises.

3. For the lower extremity involved individuals, the said novel stationary closed-kinetic chain neuromuscular device can be used with appropriate supervision to train or retrain weight bearing and muscle control of the joints of the lower extremities. The method remains closed-kinetic chain in nature with the user standing on the steel platform facing away from the steel guiderail and with the foot placement forward of the flange (heel line) and on each side of the flange, e.g. a straddle position. Caution is taken to avoid foot placement behind the flange which may result in excessive tipping of the machine. Foot placement further posterior to the heel line is of no essential value from a biomechanical perspective. Once the user assumes the initial said position, the instructor places a special pad onto the sacrum and instructs the user to lean the sacrum partially onto the center of the mobile handgrip with the user's knees fully extended. In this method, the individual is trained to partially rest their body weight from the sacrum onto the UHMWPE padded handgrip. With cueing and proper instruction, the individual may gradually apply partial body weight onto the apparatus and simultaneously onto the lower extremities. Bilateral short arcs of knee flexion will occur with a gentle squat. This novel technique may be used to aid the individual with poor vastus medialis oblique muscle firing. This dyskinesia is often seen in people with anterior knee pain syndrome. Use of said device is unique and novel because prior exercise methods and prior art have involved use of recumbent machines, squat racks, and a vertical wall to perform wall squats with or without use of a physioball or similar placed between the thoracolumbar spine and the wall to act as a friction limiting “roller bearing” for a modified squat method of exercise. Prior art literature has included use of a shuttle system in recumbent positions. Current advanced methods available to the public in gymnasiums involve high levels of balance and coordination implementing plyometric themes which are too difficult and unsafe for some users due to a high fall risk for people recovering from a lower extremity injury and/or weakness and/or balance issues.

### Prior Art

Prior art has been reviewed from multiple sources such as USPTO, Espacenet, Google Patent, and various tradeshows in the USA. Said prior art inventions are mostly absent from tradeshows further indicating the need for the said novel device.

U.S. Pat. No. 11,547,896 describes an apparatus comprising a mobile pole and sleeve that is mounted on a plurality of casters. This type of unit does not permit the safe passive range of motion needed following a recent surgery because the risk for injury to the freshly operated tissues is too high due to the instability of the unit and inability to regulate the amount of body weight necessary to achieve safe passive motion. The unit is not designed to accommodate the user's body weight for the stationary closed-kinetic chain method of active-assistive or active-resistive exercise for the upper extremity, body core or lower extremity. This unit does not accommodate the user to complete a lower extremity closed-kinetic chain neuromuscular exercise such as a partial unilateral knee squat.

U.S. Pat. No. 10,940,363 describes an apparatus comprising an adjustable bench with a variable track and sleeve with cogs. The apparatus does not permit the user to apply the much-needed body weight onto the adjustable arm to provide the user with the mechanical advantage to elevate the shoulder into flexion, abduction and a combination thereof. The apparatus does permit a smooth passive motion for the recently operated rotator cuff without undue risk of the contractive elements applying stress to the unhealed tissues. The apparatus does not permit stationary closed-chain neuromuscular lower extremity exercise.

U.S. Pat. No. 6,120,415 describes an exercise support pole apparatus. The apparatus does not permit the user with the mechanical advantage necessary to elevate the shoulder into flexion, abduction or a combination thereof using the user's body weight and weight shifting. The apparatus does permit a smooth passive motion for the recently operated rotator cuff without undue risk of the contractive elements applying stress to the unhealed tissues. The apparatus does not permit stationary closed-chain neuromuscular lower extremity exercise.

U.S. Pat. No. 5,738,616 describes a rotator cuff exercise machine and frame. The apparatus does permit a smooth passive motion for the recently operated rotator cuff without undue risk of the contractive elements applying stress to the unhealed tissues. The apparatus does not permit inclined guide rail necessary to assist shoulder flexion, abduction or a combination thereof nor core stabilization exercises. The apparatus does not permit the option for a stationary closed-chain neuromuscular lower extremity exercise.

US Patent No. 2010/0173760 A1 describes a pole apparatus which is a variation of a common wand and well-established exercise methods found in any physical therapy department in the last 50 years. The unit does not permit weight bearing, i.e. closed-kinetic chain neuromuscular loading on to the pole in a safe manner for the recently operated tissues. The exercise method is open-kinetic chain.

U.S. Pat. No. 11,173,338 describes a system and apparatus that is akin to a common finger ladder found in most rehabilitation facilities. The apparatus does not permit weight bearing and the necessary weight shifting for passive range of motion exercises. The apparatus does not permit lower extremity exercising and is substantially different from the novel apparatus mentioned above.

U.S. Pat. No. 10,780,313 B2 describes a portable mechanized strengthening apparatus. The apparatus does not permit weight bearing in a closed-kinetic chain neuromuscular exercise manner for shoulder flexion, abduction, or a combination thereof. The apparatus does not permit passive range of motion for the acute surgical shoulder repair. The apparatus does not permit closed-kinetic chain neuromuscular lower extremity exercise.

U.S. Pat. No. 8,905,950 describes a forearm support apparatus. The apparatus does not permit weight bearing using the body weight to assist in closed-kinetic chain neuromuscular shoulder flexion, abduction, or a combination thereof with an inclined shaft for assistive support.

U.S. Pat. No. 7,775,949 describes an apparatus that is a kin to the overhead pulley system which is primarily an open-kinetic chain form of exercises. The apparatus does not permit weight bearing closed-kinetic neuromuscular exercise. This unit cannot be used in Phase I for passive range of motion safely.

U.S. Pat. No. 9,522,294 B1 describes a hand cycling means of exercise for the upper extremities. The apparatus does not permit stationary weightbearing closed kinetic chain neuromuscular exercises and is a fundamentally different form of exercising from said novel apparatus.

U.S. Pat. No. 9,456,951 B2 describes an apparatus implementing closed-kinetic chain muscle strengthening in the seated position. The apparatus does not permit passive assistance for shoulder flexion using one's body weight to promote passive motion. The apparatus does not permit lower extremity exercise.

U.S. Pat. No. 6,689,030 B1 describes an apparatus directed toward shoulder physical therapy using a mobile staff. The apparatus does not permit weight bearing on an inclined shaft with a carriage handgrip to support the upper extremity in the closed-kinetic chain methods of shoulder flexion, abduction, or a combination thereof.

The Fitness Cue as described at http//www.fitnesscue.com demonstrates an apparatus directed toward open-kinetic chain wand exercises with a sliding sleeve system. The apparatus does not permit passive range of motion while protecting the recently operated soft tissues. The apparatus does not permit a stationary closed-kinetic chain method of neuromuscular exercise.

The Smith Machine shoulder strengthening system has multiple US and International Patents. The apparatus describes a body building exercise system. The apparatus does not permit low resistance, i.e. less than 1 pound as necessary for passive range of motion for the recently operated shoulder. The apparatus does not permit the inclined shaft for range of motion assistance with flexion, abduction, or a combination thereof. The Smith Machine is designed for advanced strengthening exercises in a gym setting.

### BRIEF SUMMARY OF THE INVENTION

The patent or application file contains at least one drawing executed in color. Copies of this patent or patent application publication with color drawing(s) will be provided by the Office upon request and payment of the necessary fee.

### Normal Growth and Development

Shoulder development in adolescence is typically maturing of the articular cartilage, thickening of the glenoid labrum, hypertrophy of the supporting ligaments, and development of the skeletal tissues including the roof of the shoulder, the spine of the scapula and the distal clavicle. During normal growth development shoulder movement patterns are established and stabilization of the scapula is established without teaching. Following normal growth and development the adult shoulder complex is capable of supporting the body weight and throwing a fast ball pitch in excess of 100 mph. The muscles supporting the shoulder complex allow for multiple purposes. The shoulder is the most flexible and mobile joint in the human body which allows for simple tasks such as dressing, self-hygiene, normal activities of daily living to more advanced movements such as climbing vertical canyon walls supporting the entire weight of the human body on one arm by way of the shoulder joint, arm, and hand. What s′more, the healthy well developed and appropriately trained shoulder complex can direct the force of rotation sufficient to produce a tennis ball serve at velocities in excess of 150 mph. The President's Council on Fitness suggests the standards for chin ups for growing children vary from 2 at age 6 to more than 15 chin ups by age 17 for boys. Unfortunately, because the shoulder complex is so mobile it has significant risk for injury with sports, falls on an out-stretched arm, lifting loads away from the body, and repetitive use.

### Pathology and Intervention

With age comes postural changes, the attrition of the muscle tendon units of the glenohumeral complex, muscle atrophy and boney degenerative changes resulting in shoulder pains, strains and tearing of the soft tissues. Medical professionals label the tears to the rotator cuff as partial thickness tears, full thickness tears, partial avulsions and complete avulsions. Successful rehabilitation of the injured shoulder involves a treatment plan that includes movement assessment, scapular stability exercises, mobility exercises to the joints to prevent stiffening and strengthening of the muscles when appropriate. Surgical repairs or reconstruction may involve the musculotendinous tissues being irritated to the point of bleeding and then sutured and/or anchored to the bone. Orthopaedic surgeons prefer to allow the operated shoulder tendons to rest and be immobilized following surgery to promote healing of the repaired tissues for prolonged periods. Unfortunately, prolonged immobilization has the potential to pathologically stiffen the surrounding joints soft tissues such as the joint capsule resulting in a “frozen shoulder” which defeats the purpose of the surgery from a standpoint of function. The differential diagnosis of ‘adhesive capsulitis’ creates a difficult and quite painful rehabilitation involving the aggressive mobilization of the associated soft tissues by way of a therapists using the head of the humerus as a maul to stretch the joint capsule much like a shoemaker stretches leather to accommodate the boney prominences of the foot. Unfortunately, this type of manual therapy and joint mobilization is quite painful and carries risk of tissue injuries. There are a few devices to aid the said patient in mobilizing the shoulder at the appropriate time following surgery which may be typically up to 8 weeks after surgery. Passive range of motion orders by the physician may begin earlier as an attempt to limit the pathological stiffening of the shoulder joint soft tissues. The current rehabilitation treatment protocol following rotator cuff repair, which vary by physician, is to introduce a form of forward bending at the waist followed by passive shoulder pendulum motion which is a kin to Codman's exercises. Gentle passive horizontal table wiping exercises using the non-involved side to assist the involved side in passive only movement of the involved side may be implemented also. The problem with the said limited interventions is that the motion predominantly occurs in the sagittal plane. The shoulder demands motion in all three planes, the coronal plane, horizontal or axial plane and the sagittal planes. The scapula has the unique kinematics of internal/external rotation; upward/downward rotation; and anterior/posterior tilt. The scapula is vital to normal shoulder mobility. Unfortunately, with injury the scapula frequently takes on abnormal movements (dyskinesia) that becomes problematic in returning to normal functional activities. There then is a need to promote mobility of the shoulder joint complex in all planes of motion without disturbing the operated tissues to lessen the pathological stiffening effects of prolonged immobilization and dyskinesia. The said novel invention of the stationary closed-kinetic chain standing neuromuscular exercise device consists of a stationary standing platform with an angled flange; a steel guide rail that fits into the angle flange; a sliding handgrip; and anchors above and below for providing assistive or resistive elastic tubing. The said novel apparatus provides an advantage over the limited said self-treatment methods with the ideal environment and equipment for the much needed and said passive range of motion following trauma or surgery to the shoulder complex. This method and system begin with the said novel invention by way of active support from the non-involved side. The noninvolved hand grasps the handgrip while the involved side forearm rests on the noninvolved wrist and/or forearm. Passive motion begins when the noninvolved side moves along the safe guided plane of motion that is set by the stationary angled steel bar. The steel bar serves as a guide rail which allows for directed motion in the desired anatomical planes. The handgrip or coupling device consists of an ultra-high molecular weight polyolefin (UHMWPE) plastic tube that encases specific nonlubricated press-fit steel bearings which disposes onto the said steel guiderail which promotes the well controlled and smooth motions for shoulder flexion, shoulder abduction, and/or a combination thereof. This novel technique does not significantly recruit muscle contraction of the involved side and thereby protects the repaired surgical tissues from mechanical loading while simultaneously passively moving the involved joint and thusly preventing the said scarring. The stationary closed-kinetic neuromuscular exercise apparatus can be used independently without supervision once adequate instruction and successfully demonstrated execution of the desired motion is learned by the patient for self-care in the clinic or a home with a home unit. Eventually the patient will be allowed to incorporate light muscle contraction exercises (mechanical load to the tendon) as the treatment protocol permits and the said apparatus provides the ideal machine for this task with use of the inclined guide rail directing motion using the body weight to push along (in active-assisted motion) the desired movement while continuing to protect the shoulder joint. Anchor points for resistive bands or tubing of various resistance for strengthening may be attached to various points on said novel apparatus steel platform and steel shaft. Anchors may be at the eye-loop located at the base of the steel standing platform, along the steel bar, by using a sliding anchor accessory on the steel guide rail, or by anchoring to a plurality of removable steel endcaps with eyelet or hook. The said novel apparatus eliminates the need for multiple exercise equipment stations and/or multiple locations within the clinic to progress the rehabilitation of the shoulder patient. The prior art and current clinical methods require a variety of scenarios such as use of an empty wall for wall exercises such as a finger ladder or a shoulder wheel apparatus, a resistive pulley apparatus that fits over a door or fastens to a wall anchor and the use of a special shoulder machine that is similar to a common latissimus pull-down gym machine and similar. The said prior art has limitations of the closed-kinetic chain method of neuromuscular exercises.

The said novel invention, the stationary closed chain kinetic exercise apparatus is also ideal for the neurologically impaired client (such as a stroke assault where one side of the body is weakened due to cerebral pathology) in that it allows the non-involved side upper extremity to provide guided assistance to the weakened side along an ergonomic pathway for range of motion and strengthening. The said client is able to apply gentle weightbearing by performing a whole-body partial weight shift on to the involved side to facilitate the neurological receptors of the involved shoulder, which in turn promotes cerebral facilitation to promote fresh neurological sensory and motor patterns for recruiting and gaining muscle control to the shoulders and upper extremities. The novel apparatus consists of a steel platform which provides the counterweight to support the forces applied to the guide rail. There are a set of accessories that attach to the guide rail and base platform that provides anchors for pulleys and resistive bands which serve to aid the practitioner in progressing the rehabilitation treatment plan. There is no other known single apparatus in the prior art available for the practitioner to incorporate into their treatment methods for this type of closed-kinetic chain neuromuscular rehabilitation. The standard “over the door” pulley systems and the finger ladder are not adequate initially because it requires active muscle contraction of the involved side and the involved side does not have the necessary support to protect the joint and/or surgical sites nor do they address the scapular dyskinesia. This said technology of the novel apparatus utilizes a stationary steel guide rail to support and protect the involved side by limiting the motion and by incorporating the involved side as an additional aid. Use of both upper extremities on the 12 inch tall handle provides excellent handgrip with audio biofeedback (caused by the steel ball bearings rolling on the steel shaft) to encourage the patient to move the joint with confidence and with minimal risk for applying undue mechanical stresses to the surgery or to the unstable or flaccid joint of the upper extremity.

This stationary closed-kinetic chain method of exercise requires a stable non-mobile stationary unit capable of accepting significant body weight loading. The stationary components consist of an all steel smooth plate or diamond plate pattern steel platform, a stationary steel pipe flange with a polyoxymethylene (POM) bushing and an angled stationary steel guide rail that snugly fits within the said pipe flange bushing. A plurality of steel endcaps may be fastened by way of a thumb screw to the free end of the steel guiderail to provide a stationary anchor point for a plurality of exercise equipment such as elastic resistive bands and/or tubing.

The mobile components of the said stationary closed-kinetic chain method of exercise entail partial weight bearing and weight shifting on to the ultrahigh molecular weight polyolefin (UHMWPE) plastic handgrip which contain the said bearings or may consist of a single UHMWPE bushing that acts like a carriage and move smoothly along the steel guiderail due to the low friction elements of said bushing.

### BRIEF DESCRIPTION OF THE VIEWS OF THE DRAWINGS (IF ANY)

The present invention is illustrated by way of example, and not by way of limitation, in the figures of the accompanying drawings and in which like reference numerals refer to similar elements. The embodiments of this said brief description are to be understood that the foregoing general description and the following detailed specifications and drawings are exemplary and explanatory only and are not intended to restrict the invention as embodied.

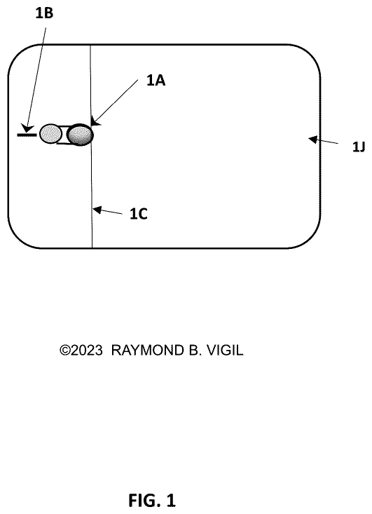

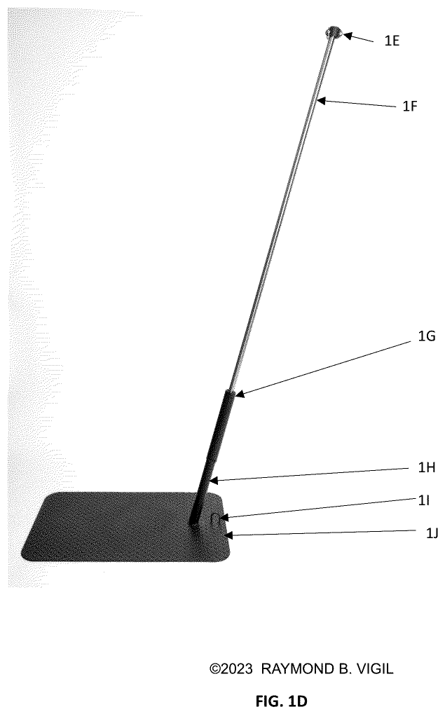

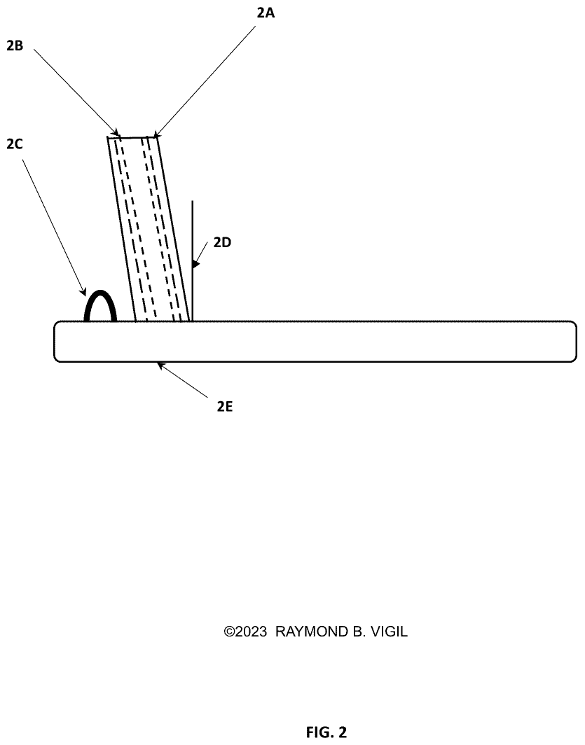

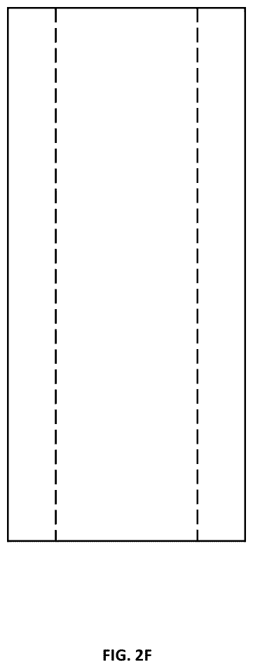

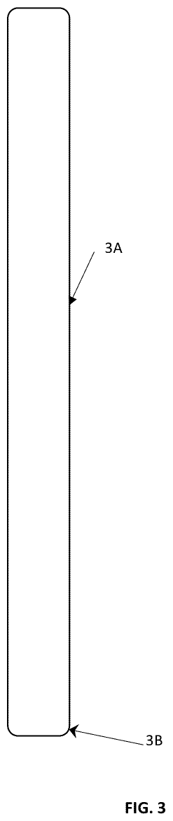

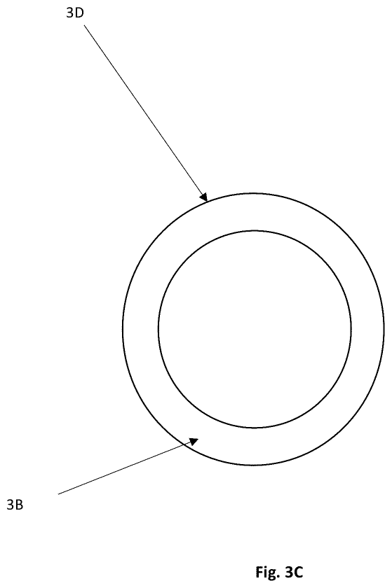

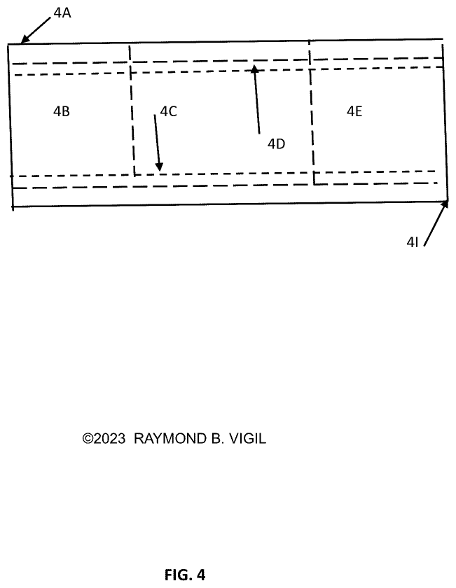

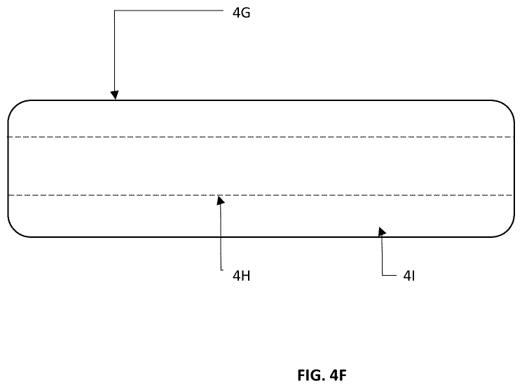

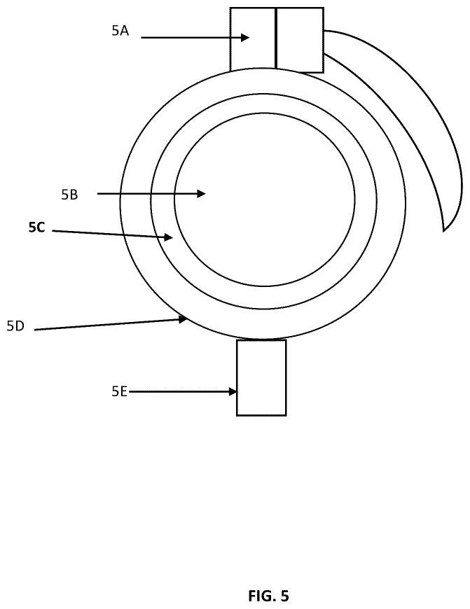

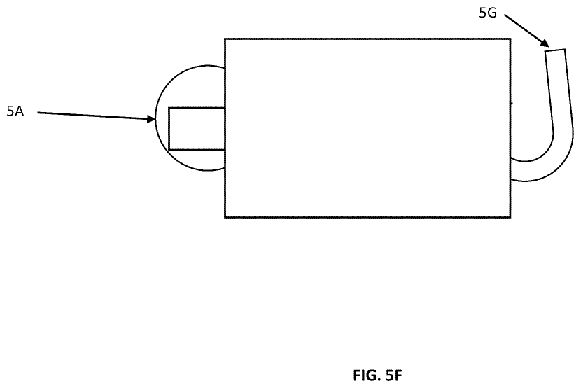

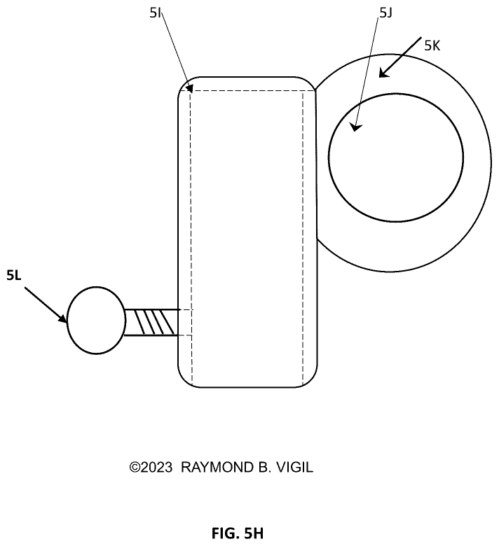

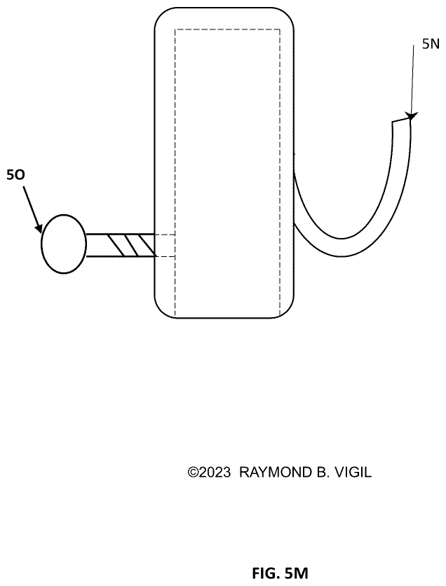

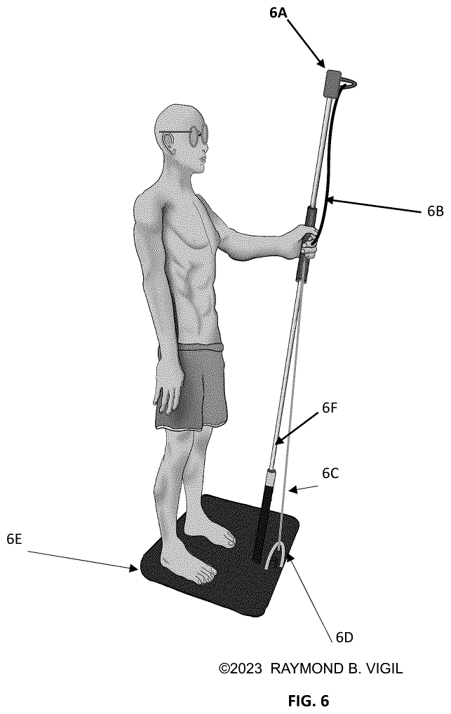

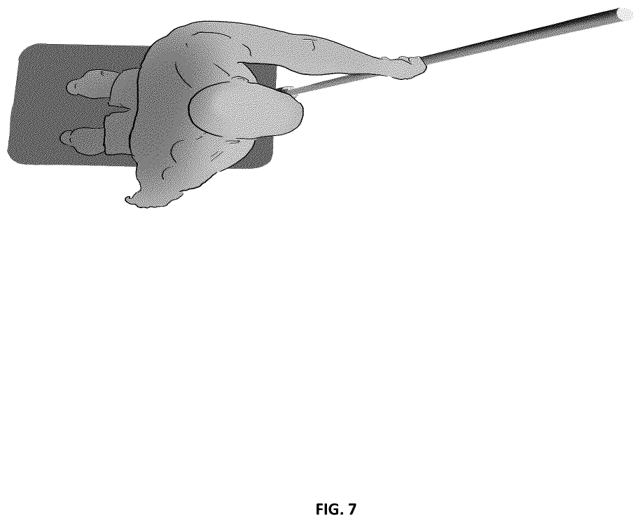

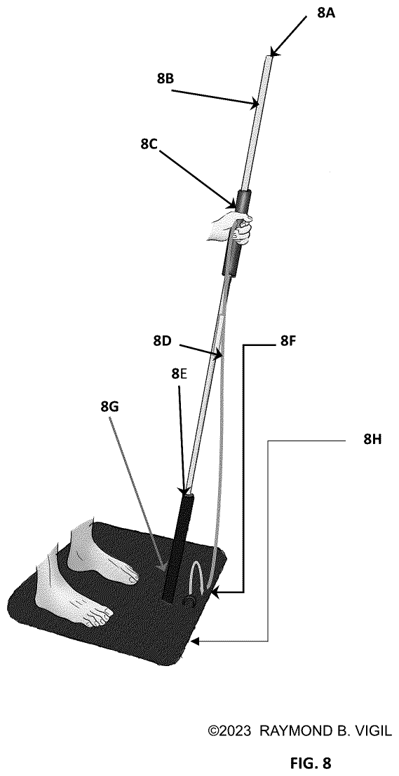

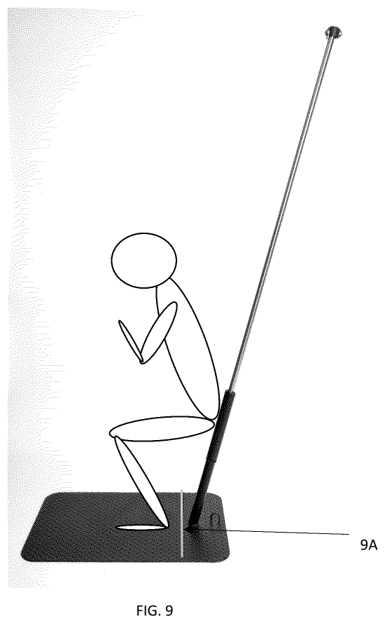

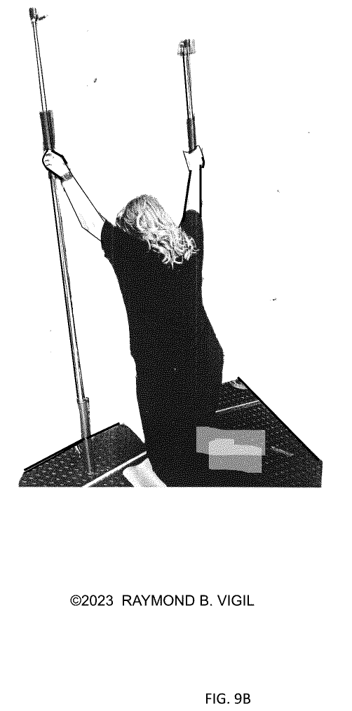

The Figures and perspectives are as follows: FIG. 1 is the top view perspective of the Steel Platform. FIG. 1A is the Steel Pipe Flange. FIG. 1B is the Inverted U-Shaped Eye Loop Anchor. FIG. 1D is the Stationary Closed-Kinetic Chain Neuromuscular Apparatus. FIG. 2 is the side perspective of the Steel Platform. FIG. 2A is the Steel Pipe Flange. FIG. 2B is the Steel Pipe Flange Bushing. FIG. 2C is the Steel Anchor Eye-Loop. FIG. 2D is the Ten to TwentyDegree Angle of the Steel Pipe Flange on the Steel Platform. FIG. 2E is the Steel Platform. FIG. 3 is the Side Perspective of the Steel Guiderail. FIG. 4 is the UHMWPE Handgrip With Stainless Steel Bearings. FIG. 4F is the UHMWPE Handgrip Bushing. FIG. 5H is the Steel Endcap With Eyelet. FIG. 5M is the Steel Endcap With Hook. FIG. 5 is the Top View Perspective of the Shaft Clamp With Hook. FIG. 5F is the Side View Perspective of the Shaft Clamp With Hook. FIG. 5L is the Thumb Screw. FIG. 6 is the Oblique View of the Stationary Closed-Kinetic Chain Neuromuscular Exercise Apparatus and User. FIG. 6A is the Endcap With Hook and Resistive Band. FIG. 6E is the Steel Base Anchor. FIG. 7 is the Top View of the Stationary Closed-Kinetic Chain Neuromuscular Exercise Apparatus and User. FIG. 8 is the Perspective of the Stationary Closed-Kinetic Chain Neuromuscular Exercise Apparatus With Hand and Foot Placements. FIG. 8A is the location for the Plurality of the Steel Endcaps. FIG. 8B is the Steel Shaft/Guiderail. FIG. 8C is the UHMWPE Handgrip. FIG. 8F is the Steel Inverted U-Shaped Eye-Loop Anchor. FIG. 8E is the POM Bushing Within Steel Pipe Flange. FIG. 8G is the Steel Pipe Flange. FIG. 8H is the Steel Standing Platform. FIG. 9 is the side perspective of the Stationary Closed-Kinetic Chain Neuromuscular Exercise Apparatus being used for lower extremity strengthening. FIG. 9A is the Heel Limit Line. FIG. 9B is a perspective of Dual Apparatus placed side by side.

### DETAILED DESCRIPTION OF THE INVENTION

Based on the description herein the invention is novel and is substantially different from what has been used or described as prior art before this filing. The subject matter sought to be patented is non-obvious to a person of ordinary or entry level skill in the arts and sciences of physical therapy, occupational therapy, athletic training, exercise physiology, personal training, recreational therapy also known collectively as “therapy and/or therapies”, and is non-obvious to the manufacturers of equipment related to the said therapies and is not-obvious to coaches, personal trainers and nor to the general public. Prior art consists of free weights, open-kinetic chain exercises, floor exercises, wall exercises and pulley devices.

Practitioners, users, and manufacturers will appreciate the disclosed novel embodiments of the said apparatus and the novel methods of stationary closed-kinetic chain neuromuscular exercises because it provides efficacious results for muscle strengthening, scapular stabilization, body core strengthening, and controlled range of motion of the extremities in weight bearing. Said practitioners of therapy and exercises may arrive with variations of disclosed methods and techniques and therefore, may implement various embodiments without altering the disclosed descriptions and subsequent claims of said novel stationary closed-kinetic chain neuromuscular exercise invention, its novel concepts and the general methods to use the apparatus for said closed-kinetic chain neuromuscular strengthening, neuromuscular exercise, muscle contraction sequencing, plyometric exercise methods and range of motion exercises.

The stationary standing posture closed-kinetic chain neuromuscular exercise device is a free-standing apparatus FIG. 1D that consists of five (5) key components FIG. 8 which consist of a steel platform consisting of a ⅜″ thick powder coated or enamel painted diamond plate A36 mild steel FIG. 8 or AISI 513 steel diamond pattern plate that forms the user's stationary standing platform FIG. 1J and has an inverted U-shaped A36 steel eye-loop FIG. 8F welded with argon and CO2 situated towards one end of the lengthwise steel plate; a polyoxymethylene (POM) bushing FIG. 2B, FIG. 2F. fits within an ergonomically angled A513 steel pipe flange FIG. 2A which is said welded towards one end of the steel platform along a centerline adjacent to the said inverted U-shaped A36 steel or AISI 513 steel eye-loop FIG. 2C; a stationary AISI 1060 hot rolled polished steel shaft of variable length which serves as a motion directed guiderail FIG. 1F which fits snugly into the POM bushing FIG. 2B that disposes within the said steel pipe flange until it bottoms out onto the said steel plate; an ultra-high molecular weight polyolefin (UHMWPE) tube handgrip FIG. 1G that slides onto the said steel shaft and travels along the said angled FIG. 2D steel stationary shaft and which serves as the ergonomic human interface to the said exercise apparatus. The UHMWPE handgrip FIG. 4 travels as a carriage by way of stainless-steel press-fit bearings FIG. 4B, FIG. 4E which dispose into the ends of the said tube handgrip FIG. 1G. The said steel standing platform FIG. 2E is a diamond plate patterned ⅜ inch said steel or said flat plate steel design that serves as a non-slip standing platform for the user to perform specific neuromuscular method of exercises for the shoulder, upper extremity, core, and lower extremity in the stationary closed-chain dependent positions. Dependent postural positions are standing, squatting, kneeling and/or sitting. An additional feature of said apparatus may be incorporated into a lower extremity stationary closed-kinetic chain neuromuscular exercise method as well FIG. 9. The said steel plate standing platform is ASTM A36 rating and serves as a counterbalance and stabilizer to the apparatus to prohibit any motion of the platform or said steel guiderail when in use. Errant or aberrant guiderail and/or platform motions of any amplitude may be detrimental to recent unhealed injuries or to the user's surgical sites if present. On one end of the said steel plate situated adjacent to the steel pipe flange FIG. 2 is a steel inverted U-shaped eye-loop FIG. 2C that is said welded to the said steel plate along the centerline and serves as an anchor point for active-resistive elastic tubing FIG. 8D exercises fixed with a carabiner, a quick link connector, or a simple square knot or similar. The said steel shaft FIG. 3 disposes into said steel pipe flange tightly by way of the POM bushing FIG. 2F. The said steel pipe flange is located towards one end of the said rectangular shaped standing steel platform FIG. 1. The steel pipe flange FIG. 1 is composed of a seamless A513 steel pipe of 1.500 inch inside diameter FIG. 2A and with a pipe wall of 0.125-inch thick with a 1.750 inch outside diameter. The said flange is a rectangular shaped seamless steel pipe with the base cut to a 10-20-degree angle FIG. 2D, FIG. 9 from perpendicular that mimics and projects a somewhat vertical FIG. 9 linear and stationary reference angle for the stationary steel guiderail FIG. 6. The said angles correlate well to the human anatomical sagittal plane for shoulder joint flexion and the coronal plane for shoulder joint abduction or a combination thereof using the said ergonomic UHMWPE handgrip FIG. 4. Thereby, implementing a method to accommodate shoulder range of motion in multiple planes for rehabilitation or habilitation. The said angled pipe flange is angled away from the user platform FIG. 9. The said steel pipe flange is situated on the centerline located on one end of the said standing steel plate platform and is said welded to the said steel platform to form a rigid fixed base receptacle for the said steel guide rail FIG. 6F and POM bushing FIG. 8E. The steel pipe flange and the steel plate are powdered coated or painted with a limited-slip covering to resist repeated standing and walking wear. The steel pipe flange is the female receiver of the said steel platform machined to accept the said POM bushing FIG. 2F which in turn receives the said 1.000 inch diameter FIG. 3 polished steel shaft which serves as the ergonomic motion directed guide rail for upper extremity motion, lower extremity motion, and core stabilization during weight bearing. The said stationary POM bushing FIG. 2 is of sufficient length to line the entire pipe flange to stabilize the steel guiderail and to minimize loosening and to minimize wobble during exercises and to lessen the friction between the steel shaft and the steel pipe flange for disassembly when needed. The said steel shaft is designed to uncouple easily from the steel pipe flange to enable for a simple transport and/or relocation of the stationary apparatus, when necessary, by a therapist or user of average strength. The POM bushing FIG. 2F is 1.495-inch diameter with a wall thickness of 0.250-inch. The length of the POM bushing FIG. is 12 inches long. The said steel shaft which serves as a near vertical directional guiderail consists of a round 1.000 inch diameter ASIS 1060 polished steel. The length of the said steel shaft is of variable lengths ranging from 72 inches to 96 inches in length. The length of said steel shaft shall be proportional to the angle of the said pipe flange with respect to perpendicular with the said steel platform for ideal stability and to minimize the stress of torque on the said welded pipe flange joint with regard to the height of the user FIG. 6. The taller the user, the more acute angle is necessary for stability of the apparatus when in use.

A UHMWPE exercise handgrip FIG. 8C slides onto the said steel guiderail with dimensions of a 2.000 inch diameter tube to serve as the human interface component (handgrip) and also serves as a carriage to assist in moving the upper extremity in the medically desired plane of motion based on the rehabilitation protocol determined by the practitioner and user. The UHMWPE handle consists of said low coefficient of friction polyethylene plastic tube which is 12.0 inches long with 0.250-inch-thick walls. The inside diameter of the said handgrip tube receives press-fit stainless-steel bearings FIG. 4 that provides an exceptionally smooth travel along the length of the said inclined angled 1060 steel guiderail. The incline is less than vertical and is a vital component of the said apparatus and for the user to be able to direct the movement of the extremity in a prescribed manner. An additional feature of the handgrip, the POM FIG. 4F bushing handgrip is machined for a smooth low coefficient of friction material for travel along the said steel guiderail without the said press fit stainless steel bearings. The external surface of both handgrips is are micro-grooved FIG. 4G to provide a non-slip handle to skin interface. Ultra-smooth travel is necessary for the specific execution of the stationary closed-kinetic chain neuromuscular exercise and for the safest control of the directed motion of the upper extremity in the said available planes of motion. The said UHMWPE handgrip FIG. 4 when in use produces distinct sounds by the stainless steel bearings moving on the stationary polished steel bar and serves as audio feedback to the user and to the practitioner to confirm the execution of the instructed exercises. The practitioner may have the user exercise independently and the sound of the bearings traveling on the bar serves to notify the practitioner that the device is in use when the practitioner may need to divert their attention away from the user. A variation of the handle consists of substituting the said stainless-steel bearings with the said UHMWPE or POM bushings FIG. 4F solely and of similar dimensions that travels along the length of the said polished steel bar to provide the appropriate motion for shoulder movements of similar but unequaled smoothness to the said stainless steel bearings with less biofeedback sound to all within hearing range. The said UHMWPE or POM plastic bushings without the said press fit bearings serves to provide a quieter experience when exercising with the device without diminishing the quality and control for safe carriage movement with passive or active motions by the user. The said UHMWPE and POM bushings are considerably lighter in weight than the said handgrip with the said press fit bearings and serves to be an alternative feature of the apparatus to the heavier said handgrip with bearings when weight resistance is an issue for the user of the apparatus.

According to the said invention there are accessories to fix over the free end FIG. 8A of the said stainless-steel guide rail for the progressing of resistive exercise following passive only range of motion:

1. An A36 steel end cap FIG. 5H consisting of dimensions of 2.00 inches long and 1.115″ outside diameter and a.995 inside diameter FIG. 5I with 0.125″ thick walls. An A36 steel trapezoid-shaped wing or similar FIG. 5K of 0.125 thickness, a 1.00 inch in length and 0.625 inches wide with a ⅜-inch centered hole FIG. 5J is said welded to the cap lengthwise to serve as an anchor to accept a quick-link connector or carabiner which serves to anchor a reciprocal pulley and resistance bands or tubing. The steel cap and wing eyelet are coated with rubberized paint or a durable enamel paint and have a ¼-inch diameter thumb screw FIG. 5L to fix in place.

2. An A36 steel end cap FIG. 5M with dimensions of 2.00 inches long and 1.115″ outside diameter and a 0.995 inch inside diameter with 0.125-inch-thick walls. An A36 steel hook FIG. 5N with 0.25 inch diameter A36 steel rod of 4 inches in length is shaped in to a U and said welded to the cap lengthwise FIG. 5N to serve as an anchor to place elastic resistive bands FIG. 6B or tubing and/or a pulley device which serves to provide prescribed muscle strengthening resistance or active-assisted range of motion. The steel cap and hook are coated with rubberized paint or durable enamel paint and have a ¼-inch thumb screw FIG. 5O to fix in place.

3. A plastic shaft clamp FIG. 5 with a hook FIG. 5G & FIG. 5E is designed to be placed on to the said steel guiderail and positioned at a desired location along the length of the said steel shaft to serve as a stop of carriage travel and to serve as an anchor for resistive tubing. The clamp consists of an injected molded plastic split ring FIG. 5D, a ¼-inch felt donut FIG. 5C with 1.0 inch inside diameter FIG. 5B, and a locking lever FIG. 5A held in place by a 1-inch long ¼-inch threaded bolt.

In yet another feature to the invention bilateral upper extremity stationary closed-kinetic chain exercises can be attained by the user when the user is positioned between a pair of said exercise devices. The user is then directed to apply partial body weight onto bilateral upper extremities using the devices said handgrips. The stationary dependent standing position can be modified to squat, kneeling, or sitting on a physioball or stool as directed by the therapist FIG. 9B.

Another feature of the said invention, according to the invention, lower extremity and trunk training stationary closed-kinetic chain neuromuscular exercises can be instructed FIG. 9. The therapist or trainer directs the individual to stand on the said stationary steel platform with the user's spine towards the said steel guiderail and weight shifts a portion of the user's body weight onto the said handgrip with the user's sacrum while keeping both feet firmly planted at the desired and safe positions in front of the Heel Line FIG. 9A. A foam pad or similar is placed between the user's sacrum and the said handgrip. The user is then instructed to begin initiation of motion by flexing both knees simultaneously in the prescribed range of motion mimicking a wall-slide squatting motion. The advantage of this method of exercise is the said inclined steel shaft and carriage accepts a portion of the user's body weight allowing for more advantageous lower extremity muscle contractions without overpowering the user. Vertical wall slide exercises are of limited benefit due to the muscle strength required to support the user's body weight against a vertical surface. With the said closed-kinetic chain method, the therapist or trainer directs the user to maintain or correct the alignment of the lower extremities and the trunk as the knee and hip joints flex and extend. The amount of body weight transferred onto the said handgrip tube is directed by the therapist with contact guard supervision for the safe positioning of the user. Once safe execution of the stationary closed-kinetic chain neuromuscular exercise is learned by the user, the user can then be directed to advance the said neuromuscular exercise for the safe and independent execution of said exercises without contact supervision.

The use of the said stationary standing postured closed-chain neuromuscular exercise device is not limited to patients with orthopaedic conditions, neurological conditions, nor medical conditions in general, but is intended to be used to specifically improve and enhance upper and/or lower extremity strength, movement, speed and sequencing of muscle contractions and other neuromuscular attributes. The unit is also intended for the aid of the throwing athlete by strengthening the supraspinatus muscle. The unit may also be adapted to other stationary uses for plyometric and/or neuromuscular exercises for the trunk and lower extremities.

The materials aforementioned may be interchanged with similar materials e.g. stainless steel may be used in place of steel, and may do so without departing from the broader spirit and scope of the disclosures as defined in said abstract, detailed description, and the purported claims without departing from the claims and descriptions of this novel device.

The illustrations and drawings referenced in the specifications, claims, and in the Brief Description of the Several Views of the Drawings are to be regarded in an illustrative manner and are not restricted to the methods and teachings provided herein. It is evident that various modifications and changes may be made by the user skilled in the field of rehabilitation, habilitation and athletics with this novel invention and may do so without departing from the broader spirit and scope of the disclosures as defined in said abstract, detailed description, and the purported claims thereby preserving the said novel methods of exercises.

The descriptive language used to define and identify the invention are parts of speech that have been assembled, constructed, selected, and identified as individual works that make up the team of words and sentences used to best describe the embodiment of the concepts of the invention's origin and the intention for the proper and safe use of the invention. Words such as a, an, the, these, are all parts of speech such as articles, conjunctions, and referents to the context provided. The language selected may be used in singular or in plural and may be interchanged without negatively affecting the semantics and description of the invention and methods described herein. Some parts of speech used in the text may be interchanged as in using a thesaurus however, such wordsmithing does not alter the concept for the creation and proper methods of execution of this closed-kinetic chain neuromuscular exercise novel invention that has multiple purposes.

No language used in the said descriptions of the claims is intended to limit the claims of the invention. The use of examples listed are merely an attempt to conceptualize the methods and further serve as exemplary language to best illustrate the invention and are not to limit disclosures or the claims in any way unless otherwise defined. Methods of use of the invention may be executed in any suitable order. The limitations of the use of the invention are determined by the prescribing physician, the practitioner's rationale, the user's physical condition, the user's informed consent be it verbal or written and determined by the trainer and ultimately the user.

The invention claims the following:

1. The said apparatus consists of five pieces that consists of; (a) a steel diamond plate standing platform FIG. 1 with the diamond design positioned towards the user to serve as a non-slip surface with a fixed steel inverted U-shaped eye-loop 2C situated towards one end of the lengthwise steel platform serving as an anchor point for resistive rubber banding or similar using quick clips, carabiners, hand knots and similar; (b) a steel pipe flange 2A fixed adjacent to the said eye-loop at a fixed angle of 10 to 20 degrees (depending upon the length of the steel guiderail) with respect to a vertical line perpendicular to the said steel platform along the center-line and which houses a female stationary bushing 2B made of polyoxymethylene (POM) plastic; (c) a stationary polished steel shaft 1F that fits snugly and securely within the POM bushing 1H and serves as an inclined angle guiderail that provides for the unique stationary closed-kinetic chain method of neuromuscular exercising; (d) a mobile handgrip 8C that consists of an ultra-high molecular weight polyolefin (UHMWPE) tube which houses 1.000 inch inside diameter (ID) stainless steel bearing assemblies FIG. 4 that disposes onto the steel angled guiderail; and (e) a plurality of steel end caps FIG. 5H consisting of a steel cap with a U-shaped hook fashioned of ⅛″ diameter steel rod 5G; a steel cap consisting of a winged eyelet which serve as an anchor site for attachment of overhead rehabilitation accessories such as active-resistive elastic exercise banding and/or tubing and/or a reciprocal pulley system by way of quick connect, carabiner, hand knot or similar FIG. 5H; and a quick-lock shaft collar FIG. 5 that consist of a felt FIG. 5C or plastic interior that slips onto the said steel shaft guide rail FIG. 5B and is adjustable to provide limited said handgrip carriage travel along the steel guiderail and subsequent upper extremity movement and/or lower extremity movement along the said steel guide rail for the purpose of strengthening muscles of the upper extremity, the lower extremity and body core FIG. 6.

2. With respect to claim 1 above a POM bushing FIG. 4F may be substituted in place of the said UHMWPE handgrip with bearings to serve as a more quiet handgrip that travels along the length of the polished steel guide rail as a stationary closed-kinetic chain neuromuscular exercise to preserve passive range of motion of the involved joints and to strengthen the involved muscles when appropriate; and a flat smooth steel plate may be substituted for the said diamond plate steel platform FIG. 1 of similar dimensions which serves as a standing platform 8H for the user and acts as a stabilizing factor when in use to protect the involved joint and involved soft tissues for the upper body, lower body in a plurality of static body positions and/or in a plurality of dynamic body positions such as weight shifting the body weight on to the outstretched hand when coupled with the UHMWPE hand grip onto the steel guide rail FIG. 7 which provides passive range of motion, active-assisted range of motion and/or active-resisted range of motion for the purpose of improving muscle strength and joint range of motion or as with placing the foot onto the UHMWPE handgrip or onto the POM bushing handgrip and applying body weight on to the guide rail by way of the handgrip to serve as an assistive strengthening device for dancers who desire to strengthen the core body musculature while dynamically moving the non-weight bearing leg in support positions along the length of the steel guide rail with varying weight shifts from the weight bearing leg of the steel platform onto the steel guiderail via the said handgrip.

3. With respect to claim 1 above the steel plate standing platform is a steel base of sufficient length, width, thickness dimensions and weight so as to stabilize the apparatus at rest and serves to stabilize the apparatus when in use by the user, regardless of body weight, serving as a stationary counter-balance of the said apparatus which prevents any tipping of the whole with the user in position when the body weight transfers weight from the steel platform onto the steel guiderail by way of the extremity wherewith the combined weight of the user and the steel bar on the said steel plate act conjointly as counter balance to the forces generated by the user when weight shifting onto the said steel guide rail with the added weight of the extremity or said body core when projecting weight beyond the stationary steel base of support to maintain stability of the whole and to sustain the desired angle of motion to the extremity on the guide rail without aberrations of movement in the axial plane which acts to minimize the risk of deleterious forces from being transferred onto soft tissues, boney tissues, surgical anchors and such when in use by the user whose guided activity generates the said physical forces when performing weight bearing weight shifts on the stationary closed-kinetic chain neuromuscular exercise apparatus which produces a weight force onto the steel guiderail that falls beyond the steel platform edge but remains stable and secure due to the said counter-balance design, angle of said flange, design of said steel guide rail of the apparatus for sufficient steel strength throughout FIG. 6.

4. With respect to claim 2 above the steel shaft angled guide rail, steel flange 2A, FIG. 2F, and steel platform serve as a stationary stable platform for human positions such as erect standing, leaning in standing, squatting, squatting and leaning, sitting, sitting and leaning, kneeling, and kneeling and leaning positions whose body weight force transfers from the stationary steel platform onto the 10-20 degree 2D angled steel guide rail (depending on the lengths of the steel shaft) which attenuates the torque forces generated by the user's body weight shift(s) by way of the steel guide rail being fixed to the welded steel pipe flange of sufficient design dimension and welding methods to accommodate the torque forces generated wherewith the flange disposes the said steel guide rail approximately 12 inches by way of the POM bushing 2B which serves as a force attenuating material and with the said properties to be easily be removed (disengaged) from the flange when necessary to relocate the said unit piecemeal when maneuvering the unit on carpet or flooring when a protective padding is not suitable.

5. With regard to claim 3 the said standing area platform accommodates the said steel pipe flange which is welded to the steel platform and houses the said POM bushing and a steel guide rail FIG. 3 that disposes within the said POM bushing by means of ⅛ inch chamfer FIG. 3B and with an adjacent welded steel inverted U-shaped loop 11 in the vertical plane located on the said base adjacent to the said fixed steel pipe flange to serve as an anchor point for attachment of active-resistive exercise tubing 6D or similar fastened by way of a common carabiner, a quick connect link, a swivel link, a similar coupling device or knot; the diamond plate steel base platform consists of a powder coated surface or painted surface diamond plate steel or flat plate steel which is necessary for the safe non-slip surface while the user is on the apparatus; the steel base platform anchor point is a fixed point situated 8F where it promotes the ideal angle of resistance for the recruitment of active muscle fibers of the supraspinatus; the rotator cuff, the deltoid muscles, lower trapezius, middle trapezius, serratus anterior muscles for the stabilization of the peri-scapular muscles and adds the muscle strengthening component of the apparatus with the resistive banding 6B, 6C or donned wrist cuff weight when indicated by the coach, therapist, trainer and/or user.

6. With regard to claim 3, the fixed in place steel pipe flange is situated towards one end of the said steel base plate and is fixed at an anthropometric angle of said 10-20 degree angle 1H, 2D (depending upon the length of the steel shaft) creates the ideal kenisio-physiological angle for motion to the glenohumeral joint complex and to the scapulohumeral complex with respect to the body core; the said fixed steel pipe flange is angled and welded to the said steel base plate at an ergonomically fixed position and angle from vertical 2D which produces a stationary parallel long-axis for the steel guide rail and a motion guided said UHMWPE handgrip to travel along the guide rail which progresses the upper extremity in guided movement and particularly the glenohumeral joint which is comprised of the said scapula, arm, and hand to move along the complex planes of motion of the shoulder joint which consist of glenohumeral motions, scapulothoracic motions, acromioclavicular motion, and clavicular motions FIG. 7; the said stationary steel pipe flange is fit with a POM bushing FIG. 2F of designed length, diameter, and thickness to provide the specific and necessary support for the said safe, accurate and precisely smooth travel of the said UHMWPE handgrip along the steel guide rail which is necessary for the said safe post-surgical rehabilitation motions without facilitating contractile forces during passive range of motion neuromuscular exercises and for the nonsurgical rehabilitation or strengthening which promotes flexibility to the joint complexes with the minimal of physical stress to the soft tissue structures, and surgical sites, sutures, boney anchors and similar.

7. According to claim 1 above, the exercises are stationary whole body and closed-kinetic chain neuromuscular in nature and are indicative of the manner in which the apparatus is invented for the novel engagement of the neurological receptors of the involved upper extremity and cerebral communication loop with the assisted function of the non-involved side to aid in passive range of motion exercises without soliciting active muscle fiber recruitment of the involved side wherewith stimulating the neuromuscular loop during the passive range of motion phase or phases and while weight bearing onto the involved side which recruits primitive neurological pathways for the aid in stabilizing the scapular muscles, the body core and its “slings” of ipsilateral and contralateral core stability and conversely distracting the involved upper extremity promotes relaxation of the musculature of the GH joint while simultaneously recruiting said scapular stabilization muscle contractions of the involved side upper extremity and said core slings.

8. According to claim 4 above regarding body motions, with verbal cuing and instruction by the coach, therapist, or trainer the closed-kinetic chain neuromuscular exercises may be advanced from passive motion to a plurality of active motions with or without resistance by cueing the user to weight shift onto the said steel guide rail by leaning the user's body weight onto the upper extremity FIG. 6 to facilitate, recruit, and actively contract the target muscle fibers of the supraspinatus muscle in a stationary closed-kinetic chain method specifically designed neuromuscular contraction sequencing that the said apparatus facilitates and that the said apparatus promotes for the best available anatomical and kinesiological active movement of the rotator cuff complex along the guided planes of flexion motion, abduction motion, adduction, horizontal adduction motion, horizontal abduction motion, external rotation motion, internal rotation motion, shoulder extension, and combinations thereof with or without weight shifts with or without resistance elastic bands or wrist cuff weights for restoring normal mechanics to the shoulder complexes.

9. The said stationary free standing closed-kinetic chained upper extremity exercise apparatus recruits the said supraspinatus muscle in a neuromuscular manner into an early sequence of independent muscle contractions within the rotator cuff muscle complex (comprising of the supraspinatus, the infraspinatus, the teres minor and the subscapularis with involvement from the teres major, serratus anterior and the latissimus dorsi muscles) at a timing so as to promote the movement of the humeral head onto the glenoid surface in an inferior gliding motion to further promote the centering of the humeral head on the glenoid surface which therefore facilitates the least amount of encroachment on to the soft tissues that pass between the distal inferior acromion and the head of the humerus thereby protecting the soft tissue structures from impingement or the excessive approximation of the distal acromion onto the humeral head and tuberosities both greater and lesser dependent on the degree of internal rotation or external rotation of the humerus.

10. With regard to claim 4, the said neuromuscular stationary apparatus can be broken down for ease of transport; the said steel pipe flange POM FIG. 2B, FIG. 2F bushing is machined to specific tolerance to 0.001 inch with properties to easily slide without lubrication oils or greases into position (engages) within the said flange and slides easily out of position (disengages) of the said flange without play or wobble 2B; the said steel shaft/guide rail is designed to be inserted FIG. 1D into the said POM bushing to be withdrawn from the said bushing to aid in the ease of relocating the said stationary device and its components as needed by the practitioner or trainer.

11. With regard to claim 1 the motion directed guide rail consists of a polished steel shaft FIG. 3 of specific lengths 3A diameter 3D and quality (1060 cold rolled steel) to accommodate the anthropometry and weight of the human upper extremity with simultaneous body weight bearing on to the outstretched arm and grasping hand FIG. 6 (or, with a grasping cuff and wrist support for individuals who lack sufficient hand grasping function), for the ideal muscular controlled motion of the shoulder complex with the user in standing, squatting FIG. 9, kneeling, or seated on the platform as said counter-weight; the said steel shaft consists of weight and dimensions to provide the physical properties and qualities necessary to support the users body weight for the stationary closed-kinetic chain neuromuscular exercise methods and the said steel shaft circumference is machined specifically to accept the matching bearings and/or bushings for the said smooth handgrip carriage FIG. 4 travel without loosening, wobble, or guide rail deviation from the said angle of inclination without regard to the size and weight of the said user while simultaneously promotes compressive force between the rib cage with the associated peri-scapular muscles and the outstretched hand that facilitates mechanical compression of the upper extremity onto the scapula which in turn facilitates the said neuromuscular pathways to prevent the scapula from winging dyskinesis by way of said neurological processes and pathways from the cerebral sensory cortex, motor cortex, spinal cord, associated peripheral and sensory nerves and body core for motor control of the scapula during range of motion neuromuscular exercises for the correction of excessive scapular anterior tilt, excessive internal rotation, and excessive scapular upward rotation, winging or a combination thereof.

12. With regard to claim 1 the said exercise apparatus human interface handle which is the handgrip FIG. 1G comprises of an ultra-high molecular weight polyolefin (UHMWPE) tubular configuration, the interface handle serves as a handgrip with the ideal anthropometry of the grasping and gripping 8C human hand ranging in development from 4 years of age to adult; the said interface handle consists of a specifically machined said UHMWPE tube which houses matching steel bearings FIG. 4, FIG. 4B, FIG. 4E that serve as a non-stationary mechanism for travel of the handgrip on said inclined and stationary steel guiderail along the long axis of the shaft and simultaneously the horizontal axis of the shaft; the said handgrip may be substituted in a variation that consists of said POM tube FIG. 4F without the said steel bearings using the said plastic material that produces a low coefficient of friction for ultra-smooth and quiet travel of the handgrip for well controlled movements 4C, 4D; the handgrips are micro grooved 4A in a tight ( 1/64 In. spacing) circular pattern providing for a textured non-slip surface which is tolerant of repeated cleaning with antiseptic solutions and the handgrip walls are of sufficient thickness 4I to support and attenuate external forces supplied by the user during neuromuscular weight bearing and non-weight bearing exercises.

13. With regard to claim 1 the said stationary exercise apparatus provides for passive and active-assistive range of motion by the user to the targeted said upper extremity glenohumeral joint and scapulothoracic joint and body core with the active use of the non-involved side to promote the passive and/or active-assisted motions of the involved side upper extremity or a combination thereof in order to minimize limited shoulder mobility mal-effects, upper extremity swelling, reflex sympathetic dystrophy symptoms, Chronic Regional Pain Syndrome (CRPS), shoulder stiffness, Thoracic Outlet Syndrome (TOS) symptoms, frozen shoulder symptoms for the said passive range of motion, the said active range of motion, and the said active-assistive range of motion exercises or a combination thereof with or without resistance; the said apparatus promotes motion to the upper extremity glenohumeral joints when the user's body weight is shifted onto the said inclined angled steel guiderail and travels with or without shaft locks FIG. 5 when instructed to do so by the therapist, coach or trainer.

14. Healthy (absent of pathology) throwing athletes benefit from the said stationary closed-kinetic chain neuromuscular exercise device when used as a method of training by whole body weight shifting incorporating the proprioceptive neuromuscular structures and muscular slings of the lower extremities, torso and thorax on to the desired upper extremity and thus promoting weight bearing of the humeral head onto the glenoid thus creating the closed-kinetic chain biophysical conditions; the said apparatus, simultaneously produces weight bearing mechanical effects of the glenoid approximating the humerus which simultaneously elicits neurological stimuli for isolating the neuromuscular firing order of the supraspinatus muscle within the rotator cuff muscle group into a pattern that mechanically positions the head of the humerus inferiorly on the glenoid surface (termed centering) to provide the mechanical advantage for specific muscle strengthening and an appropriate position of the humeral head on the glenoid located inferiorly to the acromion to allow for necessary free passage of the rotator cuff tendon inferior to the acromion; the said clearance is provided by the active contraction of the supraspinatus muscle and tendon by way of an isolating neuromuscular contraction exercise to the supraspinatus without hinderance of approximating the adjacent boney and soft tissues; such an encroachment has been termed impingement caused by the premature muscle contraction of the deltoid muscles which easily over power the tiny supraspinatus muscle.

15. As per claim 2 above the said steel bearings with said UHMWPE tube FIG. 4 and POM 4F bushings provide exceptionally smooth administered motion which is controlled in part by the user's partial body weight shifting onto the steel guide rail for the said closed-kinetic chain neuromuscular exercises; by leaning away from the steel guide rail while maintaining an adequate grasp on the handgrip produces a distraction or an unloading of the joint surfaces which produces inhibition of the neurological sensory stimuli for protective muscle guarding therefore, creating the ideal situation necessary for exacting the necessary passive mobility of the shoulder joint while protecting the surgical soft tissues; in the absence of said surgical factors the inhibition of muscle guarding creates the similar ideal situation for the said passive and/or active mobility of the non-surgical upper extremity joints in the desired planes of motion using the said UHMWPE and POM handgrips.

16. With regard to claims 1 and 12 the said handgrip bearings FIG. 4 and/or handgrip POM 4F bushing allow for ergonomic accommodations of the hand and wrist complex by providing for a flexible motion of the wrist by way of rotation about the y-axis with simultaneous travel along the longitudinal axis of the said steel guiderail for the anthropometry of shoulder passive or active flexion, abduction, horizontal abduction, horizontal adduction, or a combination thereof in standing, kneeling, squatting or sitting postures and positions with or without leaning into or away from the steel guiderail; the said steel bearing unit and/or said UHMWPE/POM bushing alternatives have the distinct advantage of providing an ergonomic y-axis rotational component of the wrist and hand on the long axis of the steel guiderail which accommodates the natural kinesiological motions with variations and normal mechanics of the functioning shoulder complex, body core and lower extremities or a combination thereof with normal hand grasp strength or with the aid of a hand grasp orthotic.

17. As per claim 1, the said bearing handle and the said base plate pipe flange bushing 2F are non-conducting materials which limit the potential discharge of electrical static buildup and discharge to the said steel platform.

18. The said stationary closed-kinetic chain exercise apparatus accomplishes modified Proprioceptive Neuromuscular Facilitation (PNF) pattern exercises as defined by physical therapist pioneers Maggie Knott and Dorothy Voss, when the user implements closed-chain weight shifts in a specific pattern and footsteps with simultaneous Diagonal-1 (D1) or Diagonal-2 (D2) upper extremity said active motions with respect to the thorax and torso facilitating the necessary body movements for the closed-kinetic chain neuromuscular exercise to create the PNF Diagonal 1 or Diagonal 2 patterns with the upper extremity producing core strengthening and distal mobility of the extremity which is entirely unique and novel to shoulder rehabilitation in the dependent upright closed-kinetic chain positions in the physical therapy profession.

19. With regard to claim 12 the said hand grip and said steel bearing carriage unit and the said UHMWPE and/or said POM bushing variation alternatives, serve in near identical capacities by providing a low coefficient of friction resistance with motions along the said steel shaft; the said bearings or the said bushings are disposed onto the said stationary steel guide rail on the non-fixed end and which is the ergonomically angled stationary component that creates the unique closed-kinetic chain element to the standing, kneeling, squatting or sitting neuromuscular exercise methods and systems for facilitating high repetitions with low resistance passive range of motion, active-assistive range of motion, active-resistive range of motion, and neuromuscular contractions resulting in improved scapular stability, range of joint motion and subsequent muscle strengthening of the involved extremity and provides the practitioner a novel neuromuscular exercise alternative based on differential diagnosis and user needs.

20. The angle of the said steel guide rail is unique with the said angle being precise and proportional to the functional anthropometry of the upper extremity and shoulder girdle and thorax which allows for ideal glenohumeral joint loading and appropriate neutral positioning of the scapula on the posterior rib cage; the said angle allows for the physiologically correct glenohumeral motion to scapulothoracic motion ratio which results in enhanced functional shoulder flexion, abduction, horizontal abduction or a combination thereof promoting and facilitating the muscle stabilizers of the scapula FIG. 7 and thereby minimizing and/or eliminating said scapular winging dyskinesia and subsequent encroachment of the distal inferior acromion onto the humerus which then facilitates the pathological loading upon the adjacent tendons, related soft tissues and bone.

21. The said handgrips provide the practitioner and user with the sound of the bearings (audio feedback) traveling on the bar 4B, 4E which serves to notify the practitioner that the device is in use when the practitioner needs to divert attention away from the user; the said UHMWPE and POM plastic bushings serves to provide a quieter experience when exercising with the device without diminishing the quality and control for said safe passive or active motions of the handgrip on the said steel guiderail.

22. Weight bearing on to the steel shaft with the upper extremity serves to assist the user to retract and stabilize the scapula in the scapulothoracic plane which aids in limiting the said dyskinesia scapular winging pathological phenomena when in use singularly and when two units are placed side by side in plurality for the simultaneous kneeling FIG. 9B or sitting bilateral motions of shoulder flexion, shoulder abduction or a combination thereof whereby the scapulae are captured bilaterally and do not excessively move away from the parallel rib cage but rather travel in parallel motion to the stationary rib cage for ideal scapular flexion termed scaption which is defined as a combination of shoulder abduction with flexion in the scapular plane of motion which is defined as an oblique perspective of the upper extremity and the scapular motion.

23. Methods of the said neuromuscular exercise proprietary techniques and instruction include but are not limited to a position similar to the O'Brien Orthopaedic Test, i.e. starting the exercise with the upper extremity out-stretched with the arm at side of the body, the user reaches for the handgrip with the hand in the thumb down position and grasps the said handgrip to initiate said scaption keeping the thumb down (internal rotation) FIG. 7 all while weight bearing onto the handgrip and adding light assistance as needed (by way of adding a resistive tubing with anchor clip to the superior end-cap 1E anchor hook or eyelet and stretching the tubing and grasping it between the said handgrip and palm grip) 6B so as to not overpower the supraspinatus muscle while neuromuscularly holding the clavicle level, the said assistance is by way of using the natural contraction properties of the elastic band to aid the weakened muscle(s) complete the desired cycle of exercises; also the non-involved side is able to assist the involved side with a bilateral grasp method whereby there is an active-assisted method of flexion only exercise; a variation of active-assisted range of motion is obtained while gently leaning into the handgrip with the elbow rigid in neutral extension and allow gravity to pull on the user's body weight onto the steel shaft on the out-stretched arm and hand FIG. 6 creating an upward force to move the shoulder active-assistively into flexion, abduction or a combination thereof by creating a compound force-counter force moment to aid the shoulder joint in pivoting about all three axis simultaneously to achieve the said shoulder flexion, abduction or a combination thereof; locking steel shaft collars disposed on to the said steel shaft FIG. 5 act as a barrier to prevent excessive elevation of the upper extremity by limiting travel along the steel shaft as determined by the practitioner or user; said shaft locks may be utilized in plurality so as to create an available arc of motion with the locks placed above and below the handgrip on the said steel guide rail; the limited arc of motions cycle avoids the impingement mechanic mal-effects, so as to inhibit the substitution muscle movement patterns such as excessive trapezius muscle contraction with clavicular elevation and restore normal motion and kinematics to the GH joint complex.

24. Lower extremity strength and mobility issues can be improved using the stationary closed-kinetic chain neuromuscular apparatus by the user assuming the standing position on the steel platform and placing the tail bone onto the handgrip using as in a straddle position FIG. 9 (with the feet shoulder width apart) with the said steel guide rail pointing away from the user 9A whose heels of the feet are placed in front of a horizontal line 1C drawn perpendicular to and tangent to the said flange 8G wherewith the neuromuscular exercise begins with a partial weight shift onto the said UHMWPE or POM handgrip and equal partial weight bearing on both legs with a bilateral squat of varying degrees of knee flexion depending upon the knee limits due to weakness and/or pathology, followed by returning to the starting position while simultaneously tapping the vastus medialis oblique muscle (VMO) with the fingers or similar for physical neuromuscular stimuli to contract the VMO during extension of the knee which in turn facilitates the neuromuscular loop from the spinal cord and cerebrum to the VMO muscle of the knee for the successful muscle contraction which aids the patella in tracking appropriately in the patellar groove of the femur thus inhibiting lateral migration of the patella and further strengthening to the lower extremity and said body core.
